(19) United States
(12) Patent Application Publication
(10) Pub. No.: US 2009/0037517 A1
(43) Pub. Date: Feb. 5, 2009

(54) Method and system to share content between web clients

(76) Inventor: Randall Wayne Frei, San Jose, CA (US)

Correspondence Address: Randall Wayne Frei, 1265 Martin Ave, San Jose, CA, 95126, US

(21) Appl. No.: 12/218,964

(22) Filed: Jul. 21, 2008

Related U.S. Application Data
(60) Provisional application No. 60/962,901, filed on Aug. 2, 2007.

(51) Int. Cl. G06F 15/16

(52) U.S. Cl. 709/202

(57) ABSTRACT

A method and system for sharing content between web clients. Specifically, a client computes and transmits its displayed content and web client state to one or more other web clients, which display the content. This enables the web clients to share the exact displayed content, even in the presence of dynamic modifications of the content local to the client.

### CROSS-REFERENCES TO RELATED APPLICATIONS

This application is entitled to the benefit of Provisional Application #60/962,901 filed Aug. 2, 2007.

### BACKGROUND OF THE INVENTION

1. Field of the Invention

Embodiments of the present invention generally relate to a communication system and, more specifically, to the sharing of web content between users of a communication system.

2. Description of the Related Art

Web browsing is commonly a solitary experience, with a single user using a web client (also known as a web “browser”) to browse the web by themselves, and any sharing of web content is normally performed out-of-band, such as by emailing Uniform Resource Locators (URLs), adding URLs to a shared database, or other means of non-real-time communication.

Sharing URLs via these non-real-time mechanisms does not provide real-time interactivity and the shared URLs may not represent the content that is actually displayed to a user of a web site. In the presence of dynamic content, especially in a Dynamic HyperText Markup Language (DHTML) environment, viewed web content is often modified without a corresponding modification of the URL. For instance, a map can be scrolled, a menu expanded or an icon dragged, without a corresponding change in the URL.

The web content that a user views in a DHTML environment includes the downloaded HyperText Markup Language (HTML), plus any additional modifications made to the web client's representation of the downloaded web page (referred to as the Document Object Model, or DOM, in this context) via client-side programs. Modifications to the DOM are commonly made by a web client's integrated scripting functionality, often controlled by code written in the JavaScript programming language, based on events that occur within the web client. For example, Google Maps (maps.google.com) displays different map views based on DOM modifications controlled by JavaScript event handlers that are executed when a user clicks on map objects. If a user clicks on the map scale icon, a web client event processing routine is launched and a JavaScript program executes and calls web client Application Programming Interface (API) functions to dynamically manipulate the web client's DOM, in order to display new images on the screen.

In this way, the user's view of the web page can include dynamic content changes made to the current DOM. Using API calls that allow further data to be retrieved from a server (for example, using an XMLHttpRequest or ActiveX object), additional web content can be retrieved and displayed without loading a new HTML page from the web server. The dynamic DOM updates via client-side scripting are a component of DHTML, while the retrieval of additional data from a server and the subsequent DOM updates, without reloading a new web page, is sometimes referred to as Web 2.0 or Ajax (the latter term is used when the data retrieved from the server is encoded in eXtensible Markup Language, or XML).

These dynamic web technologies make it ineffective to share web content by simply sharing URLs.

A potential solution to shared real-time web browsing (or “co-browsing”) in a dynamic HTML environment is the use of downloaded applications or applets (such as Java applets). The downloaded application can monitor the images displayed on the computer screen, and share the image captures with a companion program or applet on a second user's computer, over a network, which could then display the images for the second user.

However, these downloaded programs usually require an intermediate step of downloading and installing software packages on the user's computer. Additionally, these downloaded applications may limit the accessibility of the shared browsing software since there are computer operating system requirements for the downloaded software, and even if the program is implemented in a portable language such as Java, not all devices are capable of executing Java code. For instance, a mobile phone with a web client would not be able to download and execute a sharing application created for a Microsoft Windows computer, and many mobile phones do not support Java. And, downloaded programs create a security risk due to the potential for viruses and other malicious code execution.

Additionally, the sharing of image captures of the user's screen is inefficient due to the size of the transferred images, and capturing and processing the images is computational expensive.

In order to more efficiently handle dynamic HTML web page updates, at least one solution has been proposed that relies on cooperating web clients each downloading the same exact web content (either directly from the same web site, through an intermediate server, or from a server cache). At least one additional solution has been proposed that further includes capturing limited events in one web client, and then sending those events to the other web clients via a collaboration server. One problem with such systems is that the combination of the original web page content plus any web client events may not result in identical web page views, potentially due to temporal dependency of the events.

For instance, a popular example of a DHTML web page consists of a counter that simply increments once a second after the page is loaded. Using an event capturing mechanism would result in two problems. One problem is that a second web client would have both its own locally generated timer events in addition to the shared timer events from the first web client. A second, larger problem is that the resulting web page counter would be based the initial content at the time at which the page is loaded plus modifications due to timer events that subsequently occur, so if the first and second web client pages were loaded at different times, the resulting counters would be different. For example, if the example web page has a counter that starts at 0 and is incremented once per second, and a first web client is loaded at 12:00:00 while a second web client is loaded at 12:00:03, seven seconds later (at 12:00:10) the first web client will display a counter value of 10 while the second web client will display a counter value of 7. This is an extremely simple example used to illustrate how identical content loaded at slightly different times can produce different results, even if web client events are shared, and is just one of the problems that a system based on shared web content along with event capturing would encounter. Another simple example that illustrates issues with such as model is the use of random number generation on a web page, since the initial web pages would likely show different values on each web client, even if identical web pages are initially retrieved.

### SUMMARY OF THE INVENTION

The present invention provides a method to share web content between two or more users (at least one “parent” web client that controls the session content, plus one or more “child” web clients that view the parent web client's content), across a computer network such as the Internet, without requiring any operating system installed software packages or applications beyond a standard web browser that supports DHTML and client-side scripting or browser plug-ins. Embodiments of the invention allow any web site to be shared, without requiring the shared web site's participation in the co-browsing system and regardless of the Domain Name System (DNS) domain of the shared web site. The invention allows the parent browser to simply browse web sites normally, while the child browsers automatically view updates, without requiring user intervention. And, the system allows exact copies of the parent web client's content to be displayed within the child web clients, regardless of the dynamic nature of the shared content, or content modifications made locally at the parent web client.

The invention employs client-side programs (such as JavaScript programs or plug-ins such as Adobe Flash) that execute from the web client, along with server-side functions such as a relay agent. JavaScript support is commonly integrated into web clients, even lightweight clients such as web clients on mobiles phones. Note: JavaScript is different than Java, which is not normally supported by web clients, and web client plug-in applications are different than downloaded applications, since plug-in applications are controlled by, and run as companions to, the web client.

The scripts or web browser plug-ins, referred to as the web client “agent”, examine the parent web client's current DOM (which is the web client's representation of the current web content), compute a data representation of the DOM, and send or receive updates to the data representation of the DOM, in the case of a parent or child web client respectively. The updates may include the entire DOM, or may consist of differences between the old and new DOMs.

By exchanging the actual DOM content, the parent's web client content is accurately displayed on the child web clients, independent of any dynamic web content or the time at which the parent and child web clients are loaded. Additionally, even in situations where the web server would normally return different pages to the parent and child web clients (such as in the case where different cookies on the web clients would result in different web page content being returned), the child web clients will receive the exact content that the parent web client is currently viewing, due to the exchange of the actual DOM data.

An additional advantage of sharing the actual DOM content is that some additional content that is referenced from the web page's HTML, such as external stylesheets (specified though HTML “<link>” tags), appears directly within the DOM, so the content of the stylesheet source files are shared as part of the DOM sharing function. The child browser does not need to load these stylesheet files separately. And sharing the actual DOM content is efficient since the DOM consists of a well-defined, small, translatable representation of the parent web client's view.

### BRIEF DESCRIPTION OF THE DRAWINGS

FIG. 1 shows a co-browsing system with the co-browsing support integrated into a web site.

FIG. 2 shows a flow chart of the parent agent. The parent agent, implemented as a client-side script such as JavaScript or as a web client plug-in application, starts execution 202 once it is downloaded. It examines the web client's DOM 203 and sends the initial DOM 205, or any subsequent updates to the DOM 206, to the relay agent. After each examination of the DOM 203 and potential transmission of DOM updates 205/206 to the relay agent, the parent agent waits for a polling interval 208 and then repeats the process by starting with the re-examination of the DOM 203 for any changes that have taken place since the last examination.

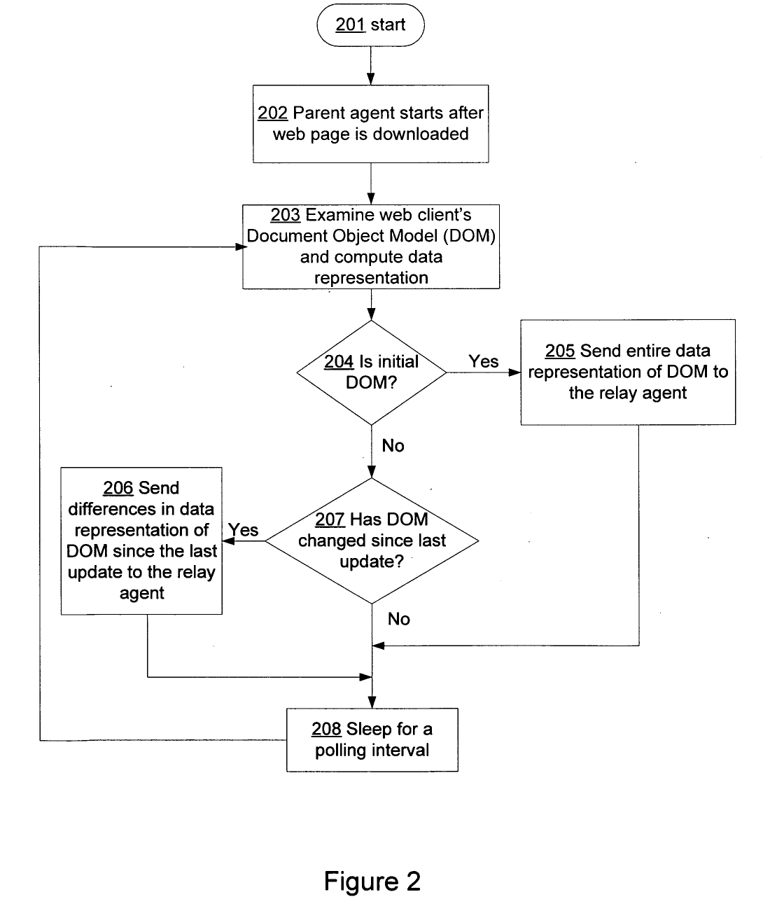

FIG. 3 shows a flow chart of the child agent. The child agent, implemented as a client-side script such as JavaScript or as a web client plug-in application, starts execution 302 once it is downloaded. The child agent polls the relay agent 303 to see if any DOM updates are available 304, and if so, the child agent updates its web client's DOM to reflect those updates 305. The child agent then waits for a period of time 306 before re-starting the process by polling the relay agent 303.

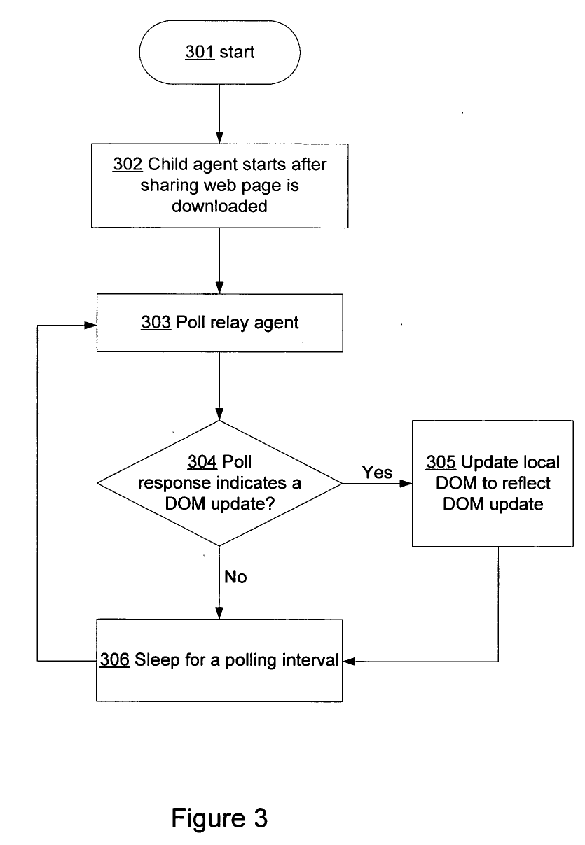

FIG. 4 shows a co-browsing system using a URL re-writing web proxy.

### DETAILED DESCRIPTION OF THE INVENTION

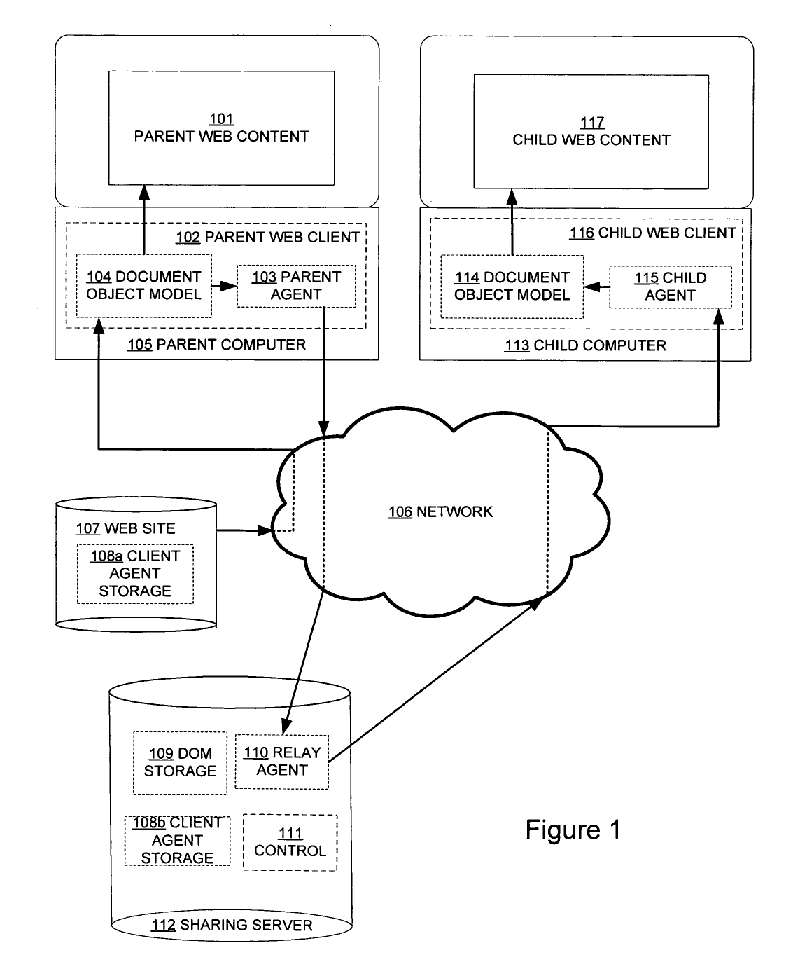

In one embodiment of the invention, the parent 102 and child 116 web clients (alternatively referred to as the “first” and “second” web clients, respectively) use standard DHTML compliant web browsers, such as Internet Explorer, FireFox or Safari running on a personal computer or mobile device such as a mobile phone. The web clients are connected to a network 106, such as a private network or the public Internet (FIG. 1's network 106 may be on the Internet). A single user's computer may have multiple web clients or multiple co-browsing sessions within a single web client (for instance, using multiple “tabs”). The use of multiple web clients or multiple sessions on a single web client could even allow a user to simultaneously be the parent of some sessions and a child of other sessions.

A co-browsing session can be initiated by the parent web client 102 accessing a web site 107 with the co-browsing agent integrated into the content returned from the web site 107. The agent can either be stored on the web site's storage 108a, or on another server such as the sharing server's 112 storage 108b. The retrieved web content would cause the parent web client's 102 downloaded co-browsing agent 103, implemented in one embodiment of the invention as a JavaScript program, to be loaded and executed. For instance, the web site's 107 content could include HTML “<script>” tags that include the parent agent 103 directly, or that direct the parent web client 102 to download the agent 103 from a server such as the sharing server 112.

Once the web content 101 and web client agent 103 are loaded, the agent 103 periodically examines the parent web client's DOM 104. In the one embodiment of the invention, a JavaScript program is used to read the current DOM 104, using DOM API calls to traverse the DOM node tree. In this way, all of the elements that make up the current DOM can be accessed and a representation of the DOM is stored into a memory buffer for further manipulation, such as comparison with an earlier copy of the DOM and a computation of any differences between the current DOM and the previous DOM. Additional DOM manipulations may include the removal of DOM objects that are not to be shared, such as non-viewable items like JavaScript programs, and the removal of the DOM elements that apply to the sharing functions themselves, such as references to the parent agent.

If any DOM 104 changes are present, or if it's the initial DOM, the parent web client agent 103 sends a data representation of the DOM, or changes to the DOM, to a relay agent 110. In one embodiment of the invention, an XMLHttpRequest operation is used to send an XML encoded representation of DOM 104 elements to the relay agent 110. Initially, the complete DOM 104 representing the initial web content 101 is sent to the relay agent 110 in order to provide the initial DOM content to the child web client 116, since if the child web client was to retrieve the initial web page directly, it might not receive the exact same web content 101 as the parent web client 102, even though the accessed URLs may be identical.

Security restrictions in many web clients prevent XMLHttpRequest operations to servers (such as the relay agent 110 server 112) that reside in a different DNS domain than the web site 107 server that provided the initial web content. In order to support relay agents 110 that reside in different DNS domains than the web site 107 that provided the initial web content, instead of using XMLHttpRequest, alternative embodiments use cross-domain communication techniques, such as HTML form posts, hidden HTML Inline Frame (“iframe”) communication, URL parameters of dynamically created server objects, HTML5 cross domain communication, or web client plug-ins.

In addition to DOM 104 updates, the parent web client 102 events may also be caught by the parent web client's agent 103 and sent to a relay agent 110. This is useful for handling any events that do not result in direct modifications to the DOM 104, such as events related to third-party browser plug-ins. For instance, the state of a video playing in a web client plug-in can be determined by events executed by or to the plug-in, or by plug-in states determined by the parent agent 103.

Once the relay agent 110 receives a DOM update, it stores the update for subsequent retrieval by the child web client's 116 agent 115. The DOM storage 109 could be implemented as a file system, or by utilizing a database (such as MySQL). The relay agent 110 may be written in any language (such as Java, Perl, PHP, Ruby or C++). The relay agent 110 may handle many connections from many parent 103 and child 115 web client agents simultaneously.

In one embodiment of the invention, a child web client 116 can join a session by using a URL which includes an identifier of a particular co-browsing session. This URL can be provided to the user of the child web client 116 directly by the user of the parent web client 102, such as by emailing the URL or sending the URL via instant messaging. The URL defines a link to access the shared content from the relay agent 110. A web cookie, or other web authentication mechanism, may be used by the relay agent 110 or sharing server control methods 111 in order to log in and authorize the child web client 116.

Once the child web client 116 joins the session by accessing the sharing server 112, the child web client agent 115 is retrieved, such as from the relay agent's 110 script storage 108b, and the child agent 115 is executed by the child web client 116. The child web client agent 115 periodically checks the relay agent 110 to see if any DOM updates are available in the DOM storage 109, and if so, the child agent 115 retrieves the DOM update and updates the child web client's 116 current DOM 114, which may result in new web content 117 being displayed for the user.

In one embodiment of the invention, the child web client's agent 115 consists of a JavaScript program that uses an XMLHttpRequest method to retrieve an XML encoded representation of the parent web client's DOM 104, or difference from the parent web client's previous DOM (and possibly any browser events), from the relay agent's 110 DOM storage 109. The child web client's DOM 114 is then updated using JavaScript DOM API calls to reflect the parent web client's current DOM 104. In addition to DOM element updates, the DOM update procedure may include the dynamic creation of new DOM nodes for certain parameters, such as HTML stylesheets, which need to be created as new DOM elements and inserted as nodes into the DOM tree for some web clients, and can not simply be updated via modifications of the DOM text, in order for these web clients to recognize such modifications. Additionally, for some web clients some DOM elements can not be modified directly once the DOM 114 is loaded (such as HTML BASE tags on some web clients), so new retrievals of web content from the relay agent 110 are used for such items. In one embodiment of the invention, when these parameters need to modified for these particular child web clients 116, the child web client agent 115 causes new web content 117 to be loaded from the sharing server 112 with these parameters set.

Updates of the child web client's 116 DOM 114 may be modified from the parent web client's DOM 104 in order to reflect the child web client's role as a viewer, such as by removing the ability to click on certain items (for instance, the HTML links may be modified so that the user of the child web client 117 can not follow links, which could cause unwanted actions such as a product being purchased on behalf of the user of the parent web client 102). These modifications could take place in the parent agent 103, the relay agent 110 or the child agent 115.

The DOM data may be translated by either the parent 103 or child agent 115, or the relay agent 110, in order to compensate for behavioral differences between parent web client 102 and the child web client 116. For instance, Firefox and Internet Explorer may have different display characteristics for some items, so some data is modified in order to better represent the parent web client's content 101 on the child web client 116. Additionally, translations are made to compensate for differences in the web client screens, for instance translating the mouse and scroll-bar positions to compensate for different window sizes.

### ALTERNATIVE EMBODIMENTS

An alternative embodiment identifies and launches sessions through the use of HTML tags embedded into the web site 107 content. Instead of the content to be co-browsed 107 automatically including the co-browsing agent 108a/b initially, it includes an HTML element that when clicked on, launches a co-browsing session. These HTML tags could easily be integrated into existing web content, such as social networking profiles, to launch co-browsing sessions of that content. For instance, a “share this” tag would allow the content of the web page containing the tag to be easily shared. Additionally, a “view me” tag placed in a social networking user's profile could allow the sharing of whatever content the corresponding user is currently viewing within the co-browsing system.

An alternative embodiment stores the parent or client agents on a server other than the sharing server 112 or web site 107. The parent and child agents are referenced through HTML tags, allowing the agents to be stored on any server.

An alternative embodiment provides for the launch of child web client 116 sessions through a management portal through co-browsing control functions 111, where sessions or users to be viewed can be selected using the portal. This has the advantage of allowing parent users to grant viewing access to other child users, who can then launch viewing sessions by simply clicking on the appropriate link corresponding to the parent user or session to be viewed, without the need to receive a URL from the parent user for a particular session. This control function 111 can be co-located on the sharing server 112, or on a separate server.

An alternative embodiment utilizes web client agents implemented as web client plug-in applications, such as Adobe Flash or Microsoft SilverLight. Depending on the web-client plug-in application, this may have the advantage of allowing communication to a relay agent 110 in a DNS domain other than that of the web site 107 that provided the web content, or it may permit direct parent agent 103 to child agent 115 communication without the use of a relay agent 110.

An alternative embodiment transmits the DOM data to the relay agent 110 as URL parameters. In this embodiment, when DOM 104 data is to be sent to the relay agent 110, the parent agent 103 creates a new element in the DOM 104 that defines a relay agent 110 based resource, such as a hidden image or JavaScript source file. The created element includes the DOM data as URL parameters which the relay agent 110 can then access when the relay agent resource is accessed on the server 112. In order to support DOM data that is larger than the URL parameters can support, multiple elements can be utilized. This embodiment has the advantage of allowing the relay agent 110 to reside in a domain other than that of the web site 107 that provided the parent web content 101.

An alternative embodiment uses an HTML form POST function to send the DOM 104 data to the relay agent 110. The HTML form's target attribute can be used to avoid the web client's page from being refreshed, such as by defining the target to be a hidden HTML iframe, so the action is transparent to the user. This embodiment has the advantage of allowing the relay agent 110 to reside in a domain other than that of the web site 107 that provided the parent web content 101.

An alternative embodiment uses a cross-domain transmission method, such as the intermediate use of a hidden HTML iframe, to communicate DOM 104 data between the parent agent 103 and a relay agent 110 residing in a domain other than that of the web site 107 that provided the parent web content 101. The parent agent 103 creates a hidden iframe within the same domain as the relay agent 110, and a cross-frame communication technique, such as URL fragment identifier exchange, is used to communicate with the parent web client's 102 hidden iframe. Since the iframe is defined to reside within the same domain as the relay agent 110, once the cross-domain communication is used to provide the DOM data to the iframe, any same-domain communication method (such as a basic XMLHttpRequest) can then be used to communicate with the relay agent 110.

An alternative embodiment uses HTML5 cross-domain communication to send the DOM 104 data to the relay agent 110. This has the advantage of allowing the relay agent 110 to reside in a domain other than that of the web site 107 that provided the parent web content 101.

An alternative embodiment uses an on-demand retrieval of a JavaScript file by the child web client's 116 agent 115 from the relay agent 110 in order for the child agent 115 to retrieve DOM update data. The JavaScript file contains executable code that updates the appropriate DOM data 114 within the child web client 116. This has the advantage of allowing the relay agent 110 to exist in a domain other than that of the server that launched the child web client 116, but only effectively works for communication from the relay agent 110 to the child agent 115, and not between the parent agent 103 and the relay agent 110, since cross-domain data can only be retrieved, and not sent, using this technique.

An alternative embodiment provides for the reversal of roles between parent and child. A user of the child web client 116 can request a role reversal, such as by clicking on a graphical element of the child web content 117, allowing the child to then become the parent of the session, and the parent to become the child.

An alternative embodiment utilizes both parent 103 and child 115 agent functionality within a single web client in order to allow multiple users to simultaneously act as parents and children of a session. For instance, one user can fill out an HTML form while the second user points to items on the form or assists by also filling out form data. Both of the web clients in this situation execute both the parent 103 and child 115 agents, and an additional merging function is used, such as on the relay agent 110, to merge the DOM updates received from the plurality of parent agents 103 of a session.

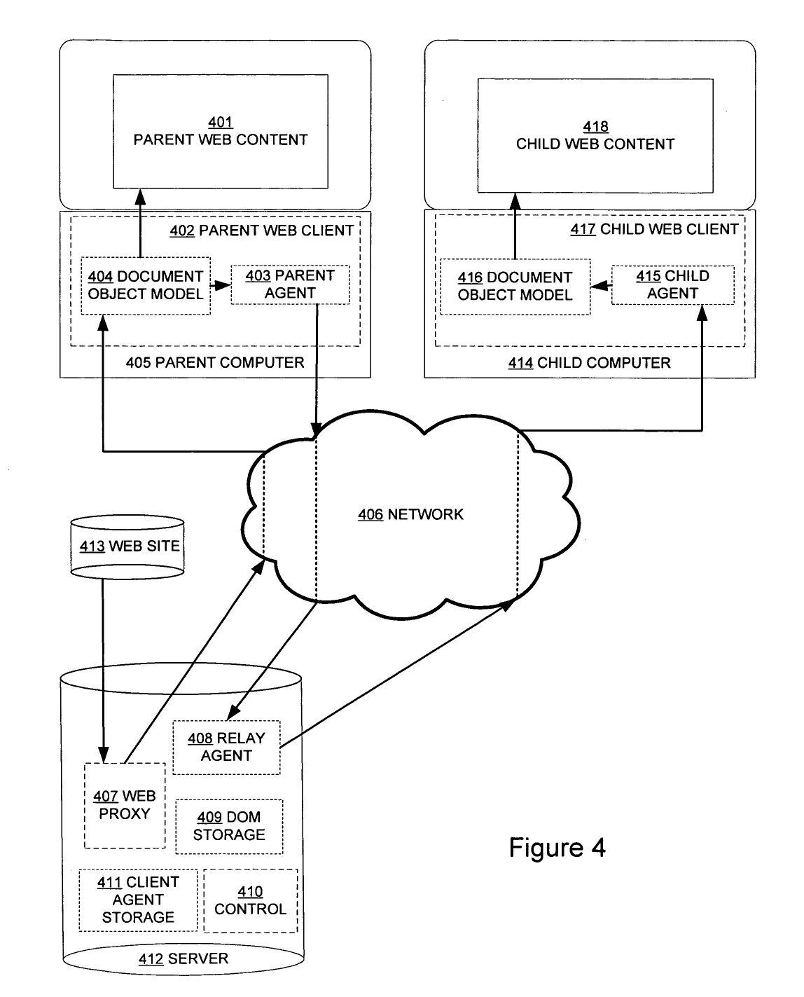

An alternative embodiment, shown in FIG. 4, utilizes a URL re-writing web proxy 407 (such as a modified version of an existing package such as CGI-Proxy) for the parent web client 402 to retrieve web site content 413.

In this embodiment, the parent web content 401 and parent agent 403 can exist in separate parent web client 402 HTML frames, or the web proxy 407 can insert the parent agent 403 directly into each web page each time a page is accessed through the web proxy 407. This allows any web site to the shared, even if the web site does not include co-browsing support.

In this embodiment, a user wishing to become parent of a browsing session accesses a control web page 410 on the server 412, and a web page is displayed that allows a URL to be entered. Alternative session launch methods include accessing the co-browsing server 412 with a URL that includes the desired web content's 413 URL as a parameter or by the server 412 using the HTTP referrer parameter to launch a session based on the referring web page.

The web proxy 407 retrieves the desired web site content 413 and returns the web content to the parent web client 402 so that the parent web client receives the web content 401 from the same domain as the relay agent 408. For instance, if a parent web client 402 requests the page “www.example.com”, the web proxy 407 translates the page so that it appears to have been generated from the web proxy 407, and by using a relay agent 408 within the same domain as the web proxy 407, the DOM 404 data can be transmitted to the relay agent 408 without encountering web client cross-domain security restrictions.

After the web proxy 407 translates the web content, the content is received by the parent web client 402. Based on data within the web content 401, the parent web client 402 might download more web pages, such as embedded images and other sub-elements of the web page. Each of these links will have previously been translated by the web proxy 407 when the web content was initially retrieved, so the subsequent requests for additional content will be made indirectly via the web proxy 407, which will once again retrieve each page, translate it and send it to the parent web client 402.

The web proxy 407 may cache certain portions of the web content for later retrieval by the child web client 417. For instance, in the event the parent agent 403 implementation does not permit access to actual image content (for instance, due to the potential inability of JavaScript implementations to access image content directly on some browsers), image files may be cached by the web proxy 407 in order to allow the child web client 417 to download those files directly from the web proxy's 407 cache. This will avoid potential authentication issues where the child web client 417 may not have authentication credentials to download the file from the original web site 413, and would increase efficiency of the web proxy 407 due to the reduction in content retrievals on behalf of the child web client 417 from the web site 413.

The web proxy 407 adds the client-side agents 411 for use by the parent 402 or child 417 web clients. One way that this can be implemented is by adding the client-side agents to a separate HTML frame in the downloaded web content, while additional frames contain the actual site content. The use of separate frames allows the client agents to stay resident in one frame, while links are followed in frames that contain the proxied web content. With this usage of frames, the main role of the web proxy 407 is to cause the web content to appear to originate from the same domain as the frame that the client agent resides within, although some additional functions may be present such as the web proxy's 407 assistance in the removal of techniques that some web sites employ to avoid being placed within HTML frames (for instance, one embodiment uses a proxy function that removes any web content that attempts to set the top level DOM location to be the actual web content, instead of the frame). In an alternative to framing, the web proxy 407 embeds the client agents 403/415 (or URL reference) directly into each web page as it is retrieved, avoiding the use of frames. Inserting the agent references directly into the content as it is retrieved maintains the presence of the agent in each web page, while avoiding any issues with HTML frames.

This web proxy embodiment has the advantage to allowing any web content to be shared (not just web content that has integrated co-browsing support), and avoids cross-domain security restrictions by allowing the web proxy 407 and relay agent 408 to reside within the same domain. And the use of the web proxy 407 causes any subsequent actions (such as a user clicking on an embedded HTML link) to result in the parent web client 402 automatically using the provided translated URL to retrieve the subsequent web content from the web proxy 407, which can then perform the next iteration of web content download, client agent insertion and web content translation before the web client receives the content. In this iterative fashion, any content on the World Wide Web can be surfed by the parent web client naturally, simply by following links embedded into the web pages, without collaboration with the web content providers.

An alternative embodiment of the web proxy model launches a session, by the co-browsing server 412, based on the HTTP referrer parameter received by the server 412 from the parent web client 402. A user launching a session in this model would simply follow a link on a web site 413 that leads to the co-browsing server 412, and the server 412 would identify the URL to be co-browsed based on the HTTP referrer parameter, and a session would be started based on the URL.

An alternative embodiment of the web proxy model launches a session based on a URL embedded as a parameter of the URL used by the parent web client 402 to access the server 412. This parameter could be specified as part of a link embedded in a web site 413, or could be created dynamically from a JavaScript function that executes as part of a parent web client's 402 bookmark feature. In this latter case, a bookmark, configured by the user, consists of a JavaScript function that examines the current URL, creates a new link to the co-browsing server 412 with the current URL as a parameter, and then causes the link to the co-browsing server 412 to be followed. In either case, the server 412 receives the URL of the content to be shared as a parameter, and initiates a sharing session based on that URL.

And alternative embodiment (referring to FIG. 1) of the invention utilizes agents 103/115 that consist of web client plug-in applications (such as Adobe Flash or Microsoft SilverLight) that are not restricted from reading data from an HTML frame from another domain. The web client plug-in agent 103/115 stays resident within the web client 102/116, such as by residing a separate HTML frame, while the web content 101/117 resides in additional frames. In this embodiment, the web site content 107 does not need to be proxied since the web client plug-in agent 103/115 is not restricted from reading content from another frame in a different domain. This embodiment does not require a web proxy 407 function, and has less bandwidth requirements on the server 112 since it does not require all accessed web content 107 to traverse the server 112.

While the forgoing is directed to embodiments of the present invention, other and further embodiments of the invention may be devised without departing from the basic scope thereof, and the scope thereof is determined by the claims that follow.

1. A method to share content between web clients wherein the content displayed on a first web client is determined, transmitted to and displayed on a second web client comprising:
determining a data representation of the first web client's current view comprising data from the first web client's Document Object Model data representation;
transferring data from an agent of the first web client to a relay agent wherein the transmitted data includes the data representation of the first web client's current view;
transferring data from the relay agent to an agent of a the second web client wherein the transmitted data contains the data representation of the first web client's current view; and
processing the received data at the agent of the second web client, and displaying the resulting view by updating the second web client's Document Object Model data representation.

2. The method of claim 1 wherein the agent comprises a JavaScript program.

3. The method of claim 1 wherein the agent comprises a web client plug-in application.

4. The method of claim 3 wherein a web client plug-in application is used which is capable of accessing web client HTML frames containing content from a different DNS domain than the web client plug-in application's domain, and the web client plug-in application resides in a separate HTML frame than the web content to be shared, and the web client plug-in accesses the DOM data of the frames containing the web content to be shared and communicates this DOM data to the relay agent.

5. The method of claim 1 wherein the data comprises state information of, or events related to, any web client plug-ins.

6. The method of claim 1 wherein the data is transformed in order to prevent the child web client from being able to interact with the viewed web content, such as removing the ability to follow links or modify data, and to remove any content that is unneeded (scripts) or undesirable (the original sharing functions such as session launch tags) for the child web client.

7. The method of claim 1 wherein the transfer of data between the web client agent and the relay agent utilizes cross-domain communication to communicate with a relay agent residing in a different domain than the domain of the server that the content was retrieved from.

8. The method of claim 1 further including the web client's retrieval of its content using a URL re-writing web proxy that retrieves and translates the web content, and inserts the co-browsing agent, in order to share content from web sites that are not necessarily enabling co-browsing support of the co-browsing system.

9. The method of claim 8 wherein the client agent resides in a separate HTML frame than the web content.

10. The method of claim 8 further including the web proxy's caching of files (such as images) retrieved by the parent web client so that references to these files in the child web client's DOM cause the cached files to be retrieved.

11. The method of claim 1 further including the translation of the data representation in order to compensate for different characteristics of different web clients.

12. The method of claim 1 wherein the data is shared from the first web client to a plurality of web clients.

13. A system to share content between web clients wherein the content displayed on a first web client is determined, transmitted to and displayed on a second web client comprising:
an agent of the first web client that determines a data representation of the web client's current view comprising data from the web client's Document Object Model data representation;
a relay agent that receives data from the agent of the first web client and communicates the data to an agent of the second web client; and
an agent of the second web client that processes the data from the relay agent and displays the resulting view by updating the second web client's Document Object Model data representation.

14. The system of claim 13 wherein the agent comprises a JavaScript program.

15. The system of claim 13 wherein the agent comprises a web client plug-in application.

16. The system of claim 13 wherein the transfer of data between the web client agent and the relay agent utilizes cross-domain communication to communicate with a relay agent residing in a different domain than the viewed content.

17. The system of claim 13 further including a URL re-writing web proxy within the same domain as the relay agent that the web client uses to retrieve its web content in order to share web content originating from a domain other than that of the relay agent.

18. A method to share content between web clients wherein the content displayed on a first web client is determined, transmitted to and displayed on a second web client comprising:
determining a data representation of the first web client's current view comprising data from the first web client's Document Object Model data representation;
transferring the data from an agent of the first web client to an agent of the second web client; and
processing the data at the agent of the second web client and displaying the resulting view by updating the second web client's Document Object Model data representation.

19. The method of claim 18 wherein the agent comprises a JavaScript application.

20. The method of claim 18 wherein the agent comprises a web client plug-in application.
